(19) United States
(12) Patent Application Publication
(10) Pub. No.: US 2026/0356175 A1
(43) Pub. Date: Nov. 12, 2026

(54) ELECTRONICALLY-CONTROLLED VEHICLE WINDOW TINTING SYSTEM

(71) Applicant: PETER ANEKWE, BROOKLYN, NY (US)

(72) Inventor: PETER ANEKWE, BROOKLYN, NY (US)

(21) Appl. No.: 19/199,532

(22) Filed: May 6, 2025

(51) Int. Cl. B60J 3/04; G02F 1/153; G02F 1/155; G02F 1/163

(52) U.S. Cl. CPC B60J 3/04; G02F 1/1533; G02F 1/155; G02F 1/163

(57) ABSTRACT

The controlled vehicle window tinting system is a transparent structure. The controlled vehicle window tinting system is a variable opacity window. The controlled vehicle window tinting system is formed from an electrochromic material. By variable opacity is meant that the level of tint of the controlled vehicle window tinting system is electrically controlled. By level of tint is meant the amount of light that passes through the transparent structure of the controlled vehicle window tinting system is adjustable. The controlled vehicle window tinting system incorporates a variable opacity structure and a power circuit. The variable opacity structure forms a solid and transparent barrier structure. The power circuit generates an electric field within the variable opacity structure that varies the level of tint of the of the variable opacity structure. The variable opacity structure remains transparent as the level of tint is adjusted.

### CROSS REFERENCES TO RELATED APPLICATIONS

Not Applicable

### STATEMENT REGARDING FEDERALLY SPONSORED RESEARCH

Not Applicable

### REFERENCE TO APPENDIX

Not Applicable

### BACKGROUND OF THE INVENTION

Not Applicable

### SUMMARY OF INVENTION

The controlled vehicle window tinting system is a transparent structure. The controlled vehicle window tinting system is a variable opacity window. The controlled vehicle window tinting system is formed from an electrochromic material. By variable opacity is meant that the level of tint of the controlled vehicle window tinting system is electrically controlled. By level of tint is meant the amount of light that passes through the transparent structure of the controlled vehicle window tinting system is adjustable. The controlled vehicle window tinting system comprises a variable opacity structure and a power circuit. The variable opacity structure forms a solid and transparent barrier structure. The power circuit generates an electric field within the variable opacity structure that varies the level of tint of the of the variable opacity structure. The variable opacity structure remains transparent as the level of tint is adjusted.

The controlled vehicle window tinting system is configured for use with a vehicle. The controlled vehicle window tinting system is intended to replace a structure within the vehicle selected from the group consisting of: a) the windshield of the vehicle; and, b) the door window of the vehicle.

These together with additional objects, features and advantages of the controlled vehicle window tinting system will be readily apparent to those of ordinary skill in the art upon reading the following detailed description of the presently preferred, but nonetheless illustrative, embodiments when taken in conjunction with the accompanying drawings.

In this respect, before explaining the current embodiments of the controlled vehicle window tinting system in detail, it is to be understood that the controlled vehicle window tinting system is not limited in its applications to the details of construction and arrangements of the components set forth in the following description or illustration. Those skilled in the art will appreciate that the concept of this disclosure may be readily utilized as a basis for the design of other structures, methods, and systems for carrying out the several purposes of the controlled vehicle window tinting system.

It is therefore important that the claims be regarded as including such equivalent construction insofar as they do not depart from the spirit and scope of the controlled vehicle window tinting system. It is also to be understood that the phraseology and terminology employed herein are for purposes of description and should not be regarded as limiting.

### BRIEF DESCRIPTION OF DRAWINGS

The accompanying drawings, which are included to provide a further understanding of the invention are incorporated in and constitute a part of this specification, illustrate an embodiment of the invention and together with the description serve to explain the principles of the invention. They are meant to be exemplary illustrations provided to enable persons skilled in the art to practice the disclosure and are not intended to limit the scope of the appended claims.

FIG. 1 is a front view of an embodiment of the disclosure.

FIG. 2 is an in-use view of an embodiment of the disclosure.

FIG. 3 is a detail view of an embodiment of the disclosure.

FIG. 4 is a front view of an alternate embodiment of the disclosure.

FIG. 5 is a detail view of an embodiment of the disclosure.

### DETAILED DESCRIPTION OF THE EMBODIMENT

The following detailed description is merely exemplary in nature and is not intended to limit the described embodiments of the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to practice the disclosure and are not intended to limit the scope of the appended claims. Furthermore, there is no intention to be bound by any expressed or implied theory presented in the preceding technical field, background, brief summary or the following detailed description.

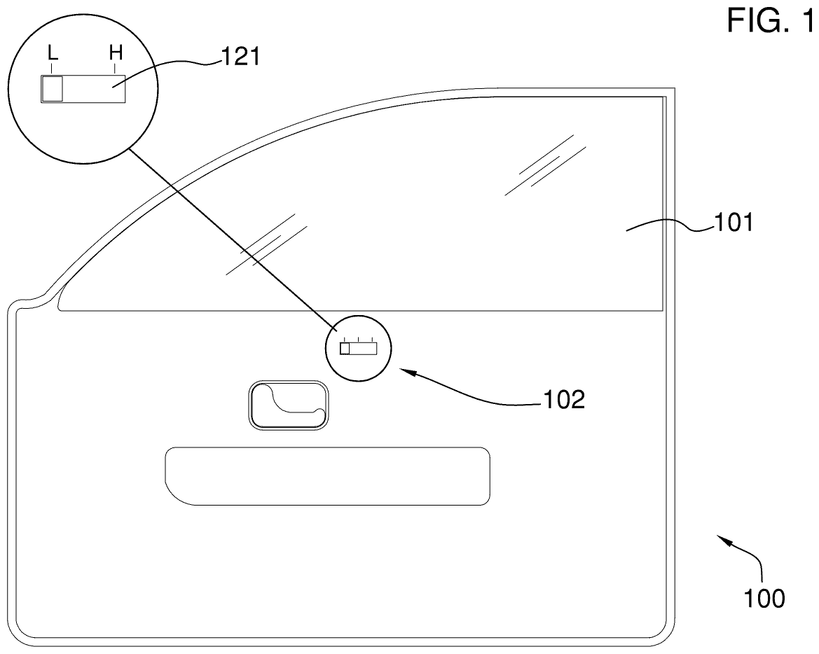

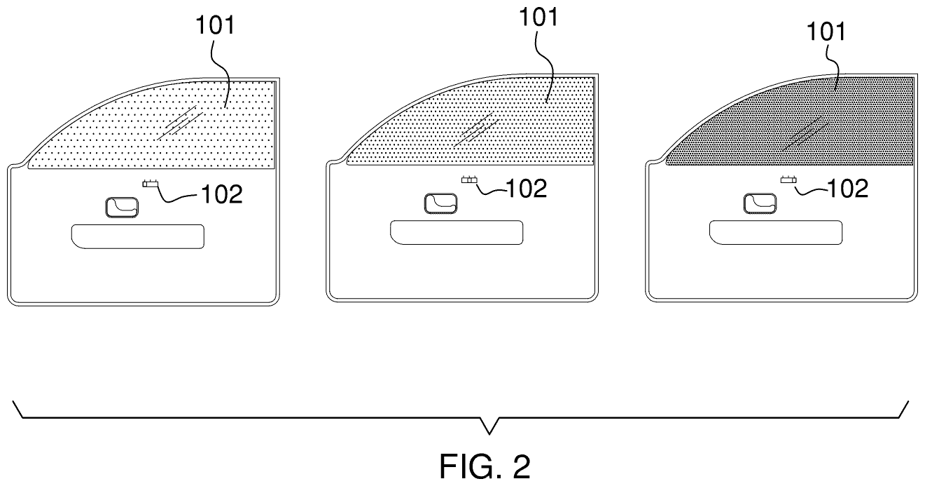

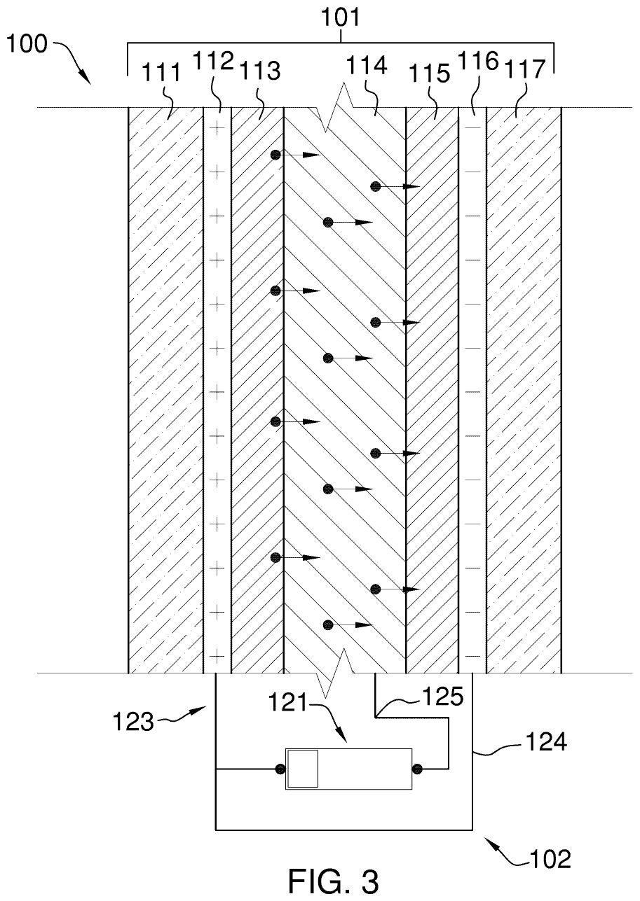

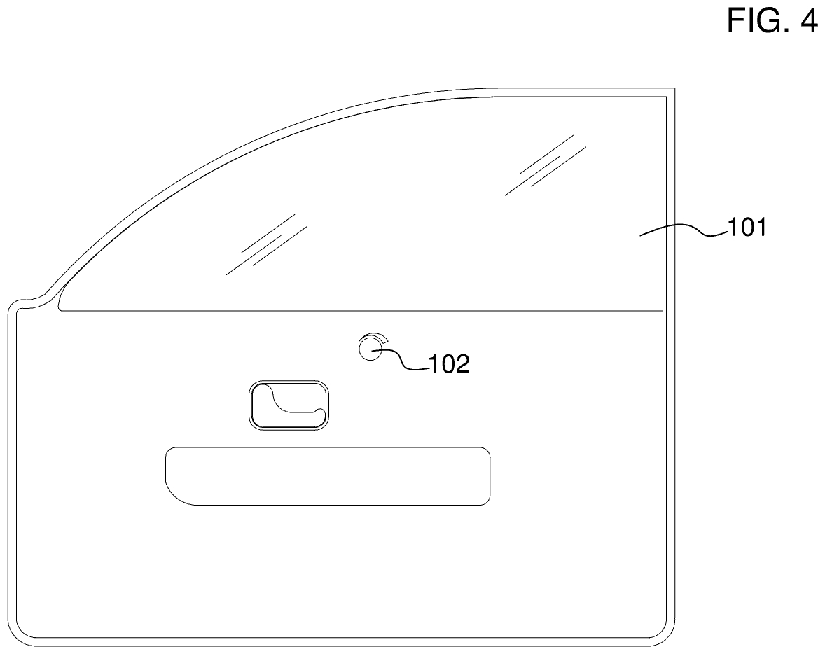

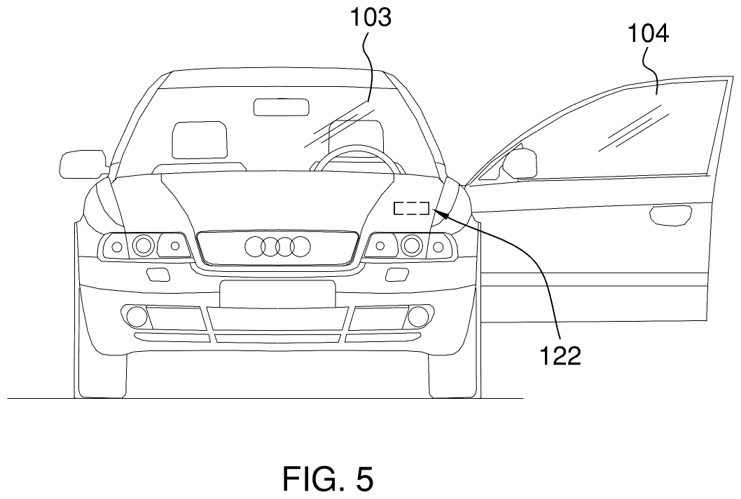

Detailed reference will now be made to one or more potential embodiments of the disclosure, which are illustrated in FIGS. 1 through 5.

The controlled vehicle window tinting system 100 (hereinafter invention) is a transparent structure. The invention 100 is a variable opacity window. The invention 100 is formed from an electrochromic material. By variable opacity is meant that the level of tint of the invention 100 is electrically controlled. By level of tint is meant the amount of light that passes through the transparent structure of the invention 100 is adjustable. The invention 100 comprises a variable opacity structure 101 and a power circuit 102. The variable opacity structure 101 forms a solid and transparent barrier structure. The power circuit 102 generates an electric field within the variable opacity structure 101 that varies the level of tint of the of the variable opacity structure 101. The variable opacity structure 101 remains transparent as the level of tint is adjusted.

The invention 100 is configured for use with a vehicle. The invention 100 is intended to replace a structure within the vehicle selected from the group consisting of: a) the windshield 103 of the vehicle; and, b) the door window 104 of the vehicle.

The variable opacity structure 101 is a window. The variable opacity structure 101 forms a transparent barrier that encloses the cab of the vehicle. The variable opacity structure 101 is formed with a variable opacity. The variable opacity structure 101 provides the visibility: a) from the environment into the cab of the vehicle; and, b) from the cab of the vehicle into the environment. The variable opacity structure 101 allows for the adjustment of the level of tint of the light that is transmitted through the variable opacity structure 101.

The variable opacity structure 101 is a disk shaped structure. The variable opacity structure 101 is a rigid structure. The variable opacity structure 101 has a composite prism structure. The composite prism structure of the variable opacity structure 101 is formed from plurality of laminae. The variable opacity structure 101 forms a barrier between the cab of the vehicle and the environment.

The variable opacity structure 101 comprises an exterior glass layer structure 111, an exterior transparent electrode structure 112, an exterior electrochromic material structure 113, a medial electrolyte solution 114, an interior electrochromic material structure 115, an interior transparent electrode structure 116, and an interior glass layer structure 117.

The exterior glass layer structure 111 forms a lamina of the composite disk structure of the variable opacity structure 101. The exterior glass layer structure 111 is a rigid structure. The exterior glass layer structure 111 is a transparent structure. The exterior glass layer structure 111 forms a congruent end of the composite disk structure of the variable opacity structure 101. The exterior glass layer structure 111 is formed from glass. The exterior glass layer structure 111 forms the exterior surface of the variable opacity structure 101 when the variable opacity structure 101 is used as a window selected from the group consisting of: a) a windshield 103; and, b) a door window 104.

The interior glass layer structure 117 forms a lamina of the composite disk structure of the variable opacity structure 101. The interior glass layer structure 117 is a rigid structure. The interior glass layer structure 117 is a transparent structure. The interior glass layer structure 117 is geometrically similar to the exterior glass layer structure 111. The interior glass layer structure 117 forms a congruent end of the composite disk structure of the variable opacity structure 101. The interior glass layer structure 117 forms the congruent end that is distal from the exterior glass layer structure 111. The interior glass layer structure 117 is formed from glass. The interior glass layer structure 117 forms the interior surface of the variable opacity structure 101 when the variable opacity structure 101 is used as a window selected from the group consisting of: a) a windshield 103; and, b) a door window 104.

The exterior transparent electrode structure 112 forms a lamina of the composite disk structure of the variable opacity structure 101. The exterior transparent electrode structure 112 is an electrically conductive mesh structure. The exterior transparent electrode structure 112 is sandwiched between the exterior glass layer structure 111 and the exterior electrochromic material structure 113. The exterior transparent electrode structure 112 is sandwiched between the exterior glass layer structure 111 and the exterior electrochromic material structure 113 such that the exterior transparent electrode structure 112 does not inhibit the visibility through the variable opacity structure 101. The exterior transparent electrode structure 112 forms an electric connection with the power circuit 102.

The exterior transparent electrode structure 112 receives a first voltage from the power circuit 102. The exterior transparent electrode structure 112 presents the first received voltage to the exterior electrochromic material structure 113. The exterior transparent electrode structure 112 is geometrically similar to the exterior electrochromic material structure 113 such that the first received voltage presented by the exterior transparent electrode structure 112 is evenly distributed over the congruent end of the exterior electrochromic material structure 113.

The interior transparent electrode structure 116 forms a lamina of the composite disk structure of the variable opacity structure 101. The interior transparent electrode structure 116 is an electrically conductive mesh structure. The interior transparent electrode structure 116 is sandwiched between the interior electrochromic material structure 115 and the interior glass layer structure 117. The interior transparent electrode structure 116 is sandwiched between the interior electrochromic material structure 115 and the interior glass layer structure 117 such that the interior transparent electrode structure 116 does not inhibit the visibility through the variable opacity structure 101. The interior transparent electrode structure 116 forms an electric connection with the power circuit 102.

The interior transparent electrode structure 116 receives the first received voltage from the power circuit 102. The first received voltage is identical to the voltage received by the exterior transparent electrode structure 112. The interior transparent electrode structure 116 presents the first received voltage to the interior electrochromic material structure 115. The interior transparent electrode structure 116 is geometrically similar to the interior electrochromic material structure 115 such that the first received voltage presented by the interior transparent electrode structure 116 is evenly distributed over the congruent end of the interior electrochromic material structure 115.

The exterior electrochromic material structure 113 forms a lamina of the composite disk structure of the variable opacity structure 101. The exterior electrochromic material structure 113 is a rigid structure. The exterior electrochromic material structure 113 is a transparent structure. The exterior electrochromic material structure 113 is geometrically similar to the exterior glass layer structure 111. The exterior electrochromic material structure 113 is sandwiched between the exterior transparent electrode structure 112 and the medial electrolyte solution 114. The exterior electrochromic material structure 113 is formed from an electrochromic material. The exterior electrochromic material structure 113 is formed from a variable opacity material. The level of tint of the exterior electrochromic material structure 113 is adjustable. The level of tint of the exterior electrochromic material structure 113 adjusts by adjusting the strength of an electric field that passes through the exterior electrochromic material structure 113.

The interior electrochromic material structure 115 forms a lamina of the composite disk structure of the variable opacity structure 101. The interior electrochromic material structure 115 is a rigid structure. The interior electrochromic material structure 115 is a transparent structure. The interior electrochromic material structure 115 is geometrically similar to the exterior glass layer structure 111. The interior electrochromic material structure 115 is sandwiched between the medial electrolyte solution 114 and the interior transparent electrode structure 116. The interior electrochromic material structure 115 is formed from an electrochromic material. The interior electrochromic material structure 115 is formed from a variable opacity material. The level of tint of the interior electrochromic material structure 115 is adjustable. The level of tint of the interior electrochromic material structure 115 adjusts by adjusting the strength of an electric field that passes through the interior electrochromic material structure 115.

The medial electrolyte solution 114 forms a lamina of the composite disk structure of the variable opacity structure 101. The medial electrolyte solution 114 is a transparent structure. The medial electrolyte solution 114 is sandwiched between the exterior electrochromic material structure 113 and the interior electrochromic material structure 115. The medial electrolyte solution 114 is a fluid impermeable structure. The medial electrolyte solution 114 is an electrically conductive structure. The medial electrolyte solution 114 contains a liquid phase electrolytic solution. The medial electrolyte solution 114 forms an electric connection with the power circuit 102.

The medial electrolyte solution 114 receives a second voltage from the power circuit 102. The magnitude of the second received voltage medial electrolyte solution 114 received from the power circuit 102 is different from the magnitude of the first received voltage applied to the exterior transparent electrode structure 112 from the power circuit 102. The magnitude of the second received voltage medial electrolyte solution 114 received from the power circuit 102 is different from the magnitude of the first received voltage applied to the interior transparent electrode structure 116 from the power circuit 102.

The medial electrolyte solution 114 presents the second received voltage to the congruent end of the exterior electrochromic material structure 113 that is distal from the exterior glass layer structure 111. The medial electrolyte solution 114 is geometrically similar to the exterior electrochromic material structure 113 such that the second received voltage presented by the medial electrolyte solution 114 is evenly distributed over the congruent end of the exterior electrochromic material structure 113.

The medial electrolyte solution 114 presents the second received voltage to the congruent end of the interior electrochromic material structure 115 that is distal from the exterior glass layer structure 111. The medial electrolyte solution 114 is geometrically similar to the interior electrochromic material structure 115 such that the second received voltage presented by the medial electrolyte solution 114 is evenly distributed over the congruent end of the interior electrochromic material structure 115.

The exterior transparent electrode structure 112, the exterior electrochromic material structure 113 and the medial electrolyte solution 114 combine to form an exterior capacitor structure. The exterior electrochromic material structure 113 and the medial electrolyte solution 114 form the conductive plates of the exterior capacitor structure. The exterior electrochromic material structure 113 forms the dielectric material of the exterior capacitor structure. The voltage differential between the exterior transparent electrode structure 112 and the medial electrolyte solution 114 forms the electric field through the exterior electrochromic material structure 113 that is used to control the level of tint of the exterior electrochromic material structure 113. The level of tint of the exterior electrochromic material structure 113 is controlled by controlling the voltage differential between the medial electrolyte solution 114 and the exterior transparent electrode structure 112.

The interior transparent electrode structure 116, the interior electrochromic material structure 115 and the medial electrolyte solution 114 combine to form an interior capacitor structure. The interior electrochromic material structure 115 and the medial electrolyte solution 114 form the conductive plates of the interior capacitor structure. The interior electrochromic material structure 115 forms the dielectric material of the interior capacitor structure. The voltage differential between the interior transparent electrode structure 116 and the medial electrolyte solution 114 forms the electric field through the interior electrochromic material structure 115 that is used to control the level of tint of the interior electrochromic material structure 115. The level of tint of the interior electrochromic material structure 115 is controlled by controlling the voltage differential between the medial electrolyte solution 114 and the interior transparent electrode structure 116.

The power circuit 102. The power circuit 102 is an electric circuit. The power circuit 102 electrically connects to the variable opacity structure 101. The power circuit 102 generates an electric field that is applied to the variable opacity structure 101. The power circuit 102 controls the level of tint of the variable opacity structure 101. The power circuit 102 comprises a voltage control structure 121, an external power source 122, an exterior electrode lead 123, an interior electrode lead 124, and an electrolyte lead 125.

The voltage control structure 121 is an electric circuit element. The voltage control structure 121 controls the flow of electric energy from the external power source 122 into the exterior electrode lead 123, the interior electrode lead 124, and the electrolyte lead 125. The voltage control structure 121 controls the voltage differential between the first voltage and the second voltage. The voltage control structure 121 applies the first voltage to the exterior electrode lead 123 and the interior electrode lead 124. The voltage control structure 121 applies the second voltage to the electrolyte lead 125. In the first potential embodiment of the disclosure, the voltage control structure 121 is a switch. In a second potential embodiment of the disclosure, the voltage control structure 121 is a potentiometer.

The external power source 122 is an externally provided source of electric energy. The external power source 122 provides the power circuit 102 with the electric energy required for operation. In the first potential embodiment of the disclosure, the external power source 122 is the electric system of the vehicle.

The exterior electrode lead 123 is an electrically conductive structure. The exterior electrode lead 123 is the structure of the power circuit 102 that conducts the first voltage from the voltage control structure 121 to the exterior transparent electrode structure 112.

The interior electrode lead 124 is an electrically conductive structure. The interior electrode lead 124 is the structure of the power circuit 102 that conducts the first voltage from the voltage control structure 121 to the interior transparent electrode structure 116.

The electrolyte lead 125 is an electrically conductive structure. The electrolyte lead 125 is the structure of the power circuit 102 that conducts the second voltage from the voltage control structure 121 to the medial electrolyte solution 114.

The following definitions were used in this disclosure:
Actuate: As used in this disclosure, to actuate means to initiate the operation of a machine, a device, or a process. The term actuate can be applied to a component of a larger machine, device or process.
Align: As used in this disclosure, align refers to an arrangement of objects that are: 1) arranged in a straight plane or line; 2) arranged to give a directional sense of a plurality of parallel planes or lines; or, 3) a first line or curve is congruent to and overlaid on a second line or curve.
Cant: As used in this disclosure, a cant is an angular deviation from one or more reference lines (or planes) such as a vertical line (or plane) or a horizontal line (or plane).
Capacitor: As used in this disclosure, a capacitor is an electrical device that is used to store an electric charge.
Center: As used in this disclosure, a center is a point that is: 1) the point within a circle that is equidistant from all the points of the circumference; 2) the point within a regular polygon that is equidistant from all the vertices of the regular polygon; 3) the point on a line that is equidistant from the ends of the line; 4) the point, pivot, or axis around which something revolves; or, 5) the centroid or first moment of an area or structure. In cases where the appropriate definition or definitions are not obvious, the fifth option should be used in interpreting the specification.
Center, Major, Minor, and Thickness Dimensions: As used in this disclosure, the center dimension, the major dimension, the minor dimension, and the thickness each refer to the span of a length associated with a structure selected from the group consisting of a prism structure and a disk structure. The center dimension is the span of the length of the center axis of the selected structure. The thickness is an alternate name given to the center dimension when the selected structure is a disk structure. The major dimension is the span of the length of the major axis of the perimetrical boundary that contains the selected structure. The minor dimension is the span of the length of the minor axis of the perimetrical boundary that contains the selected structure. The terms center dimension, the major dimension, the minor dimension, and the thickness are also used to describe one or more linear axes of direction associated with the selected structure.
Center Axis: As used in this disclosure, the center axis is the axis of a cylinder or a prism. The center axis of a prism is the line that joins the center point of the first congruent face of the prism to the center point of the second corresponding congruent face of the prism. The center axis of a pyramid refers to a line formed through the apex of the pyramid that is perpendicular to the base of the pyramid. When the center axes of two cylinder, prism or pyramidal structures share the same line they are said to be aligned. When the center axes of two cylinder, prism or pyramidal structures do not share the same line they are said to be offset.
Composite Material: As used in this disclosure, a composite material is a multilayer structure made of two or more joined layers of sheeting materials and coatings.
Composite Prism: As used in this disclosure, a composite prism refers to a structure that is formed from a plurality of structures selected from the group consisting of a prism structure, a pyramid structure, and a spherical structure. The plurality of selected structures may or may not be truncated or bifurcated. The plurality of prism structures are joined together such that the center axes of each of the plurality of structures are aligned. The congruent ends of any two structures selected from the group consisting of a prism structure and a pyramid structure need not be geometrically similar.
Composite Sheeting: As used in this disclosure, a composite sheeting is a multilayer structure made of two or more joined layers of sheeting materials.
Congruent: As used in this disclosure, congruent is a term that compares a first object to a second object. Specifically, two objects are said to be congruent when: 1) they are geometrically similar; and, 2) the first object can superimpose over the second object such that the first object aligns, within manufacturing tolerances, with the second object.
Correspond: As used in this disclosure, the term correspond is used as a comparison between two or more objects wherein one or more properties shared by the two or more objects match, agree, or align within acceptable manufacturing tolerances.
Diffraction: As used in this disclosure, diffraction refers to the expansion of the field of illumination of a ray of light as it passes an edge that blocks a portion of the field of illumination of the ray of light. Diffraction can occur around an edge or a slit. Diffraction is a wave property of light.
Disk: As used in this disclosure, a disk is a prism-shaped object that is flat in appearance. The disk is formed from two congruent ends that are attached by a lateral face. The sum of the surface areas of two congruent ends of the prism-shaped object that forms the disk is greater than the surface area of the lateral face of the prism-shaped object that forms the disk. In this disclosure, the congruent ends of the prism-shaped structure that forms the disk are referred to as the faces of the disk.
Electrochromic Material: As used in this disclosure, an electrochromic material is a substance that undergoes a reversible change in optical properties when the electrochromic material is exposed to an electric field.
Electrode: As used in this disclosure, an electrode is an electrical conductor through which electric current enters or exits a non-metallic object that is incorporated into an electric circuit. Non-metallic objects commonly used with electrodes would include, but are not limited to electrolytic solutions, semiconducting materials. The electrode is commonly used on patients undergoing medical procedures.
Electrolyte: As used in this disclosure, an electrolyte refers to ionic atomic or polyatomic compounds that dissolve in water to create an electrically conductive solution referred to as an electrolytic solution.
Environment: As used in this disclosure, an environment refers to the physical conditions surrounding an object. The term environment is often limited to the physical conditions that the object interacts with.
Exterior: As used in this disclosure, the exterior is used as a relational term that implies that an object is not contained within the boundary of a structure or a space.
External Power Source: As used in this disclosure, an external power source is a source of the energy that is externally provided to enable the operation of the present disclosure. Examples of external power sources include, but are not limited to, electrical power sources and compressed air sources.
Fluid: As used in this disclosure, a fluid refers to a state of matter wherein the matter is capable of flow and takes the shape of a container it is placed within. The term fluid commonly refers to a liquid or a gas.
Form Factor: As used in this disclosure, the term form factor refers to the size and shape of an object.
Gas: As used in this disclosure, a gas refers to a state (phase) of matter that is fluid and that fills the volume of the structure that contains it. Stated differently, the volume of a gas always equals the volume of its container.
Geometrically Similar: As used in this disclosure, geometrically similar is a term that compares a first object to a second object wherein: 1) the sides of the first object have a one to one correspondence to the sides of the second object; 2) wherein the ratio of the length of each pair of corresponding sides are equal; 3) the angles formed by the first object have a one to one correspondence to the angles of the second object; and, 4) wherein the corresponding angles are equal. The term geometrically identical refers to a situation where the ratio of the length of each pair of corresponding sides equals 1. By the term essentially geometrically similar is meant that the primary shapes of two objects are geometrically similar except that there are functional items (such as fastening devices) associated with the primary shape may not maintain the ratio for geometric similarity. By the term roughly geometrically similar is meant that the form factors between the primary shape of the two objects can vary by a factor of up to 10% when the two objects are normalized to be roughly geometrically identical.
Glass: As used in this disclosure, glass is a rigid structure that is formed by melting and then rapidly cooling a compound primarily composed of silica.
Interior: As used in this disclosure, the interior is used as a relational term that implies that an object is contained within the boundary of a structure or a space.
Lamina: As used in this disclosure, a lamina refers to an individual layer of a composite structure that is formed from a plurality of layers.
Liquid: As used in this disclosure, a liquid refers to a state (phase) of matter that is fluid and that maintains, for a given pressure, a fixed volume that is independent of the volume of the container.
Major and Minor Axes: As used in this disclosure, the major and minor axes refer to a pair of perpendicular axes that are defined within a structure. The length of the major axis is always greater than or equal to the length of the minor axis. The major axis forms the longest symmetric bifurcation of a structure selected from the group consisting of: a) the structure; or, b) the perimetrical boundary of the structure. The major and minor axes intersect at the center of the structure. The major axis is always parallel or perpendicular to an edge of a rectangular or rectilinear structure.
Negative Space: As used in this disclosure, negative space is a method of defining an object through the use of open or empty space as the definition of the object itself, or, through the use of open or empty space to describe the boundaries of an object.
One to One: When used in this disclosure, a one to one relationship means that a first element selected from a first set is in some manner connected to only one element of a second set. A one to one correspondence means that the one to one relationship exists both from the first set to the second set and from the second set to the first set. A one to one fashion means that the one to one relationship exists in only one direction. In a one to one correspondence, the first element of the first set is said to be associated to the second element of the second set to which the first element corresponds.
Opaque: As used in this disclosure, opaque refers to an object or material that prevents the passage of radiation through the object or material.
Pan: As used in this disclosure, a pan is a hollow containment structure. The pan has a shape selected from the group consisting of: a) a prism; and, b) a truncated pyramid. The pan has a single open face. The open face of the pan is often, but not always, the superior face of the pan. The open face is a surface selected from the group consisting of: a) a congruent end of the prism structure that forms the pan; b) a lateral face of the prism structure that forms the pan, c) the base face of the truncated pyramid structure; and, d) the truncated face of the truncated pyramid structure. A semi-enclosed pan refers to a pan wherein the closed end of prism structure of the pan and/or a portion of the lateral face of the pan is also open.
Perimeter: As used in this disclosure, a perimeter is one or more curved or straight lines that bounds an enclosed area on a plane or surface. The perimeter of a circle is commonly referred to as a circumference.
Perimetrical Boundary: As used in this disclosure, a perimetrical boundary is a hypothetical rectangular block that contains an object. Specifically, the rectangular block selected to be the perimetrical boundary is the rectangular block with the minimum volume that fully contains the object. In a two-dimensional structure, the perimetrical boundary is the rectangle with the minimum surface area.
Phase: As used in this disclosure, phase refers to the state of the form of matter. The common states of matter are solid, liquid, gas, and plasma.
Potentiometer: As used in this disclosure, a potentiometer is an adjustable electrical device that presents a resistance to an electric. The level of resistance is adjustable.
Primary Shape: As used in this disclosure, the primary shape refers to a description of the rough overall geometric shape of an object that is assembled from multiple components or surfaces. The term essential primary shape is used to indicate the exclusion of functional items that are attached to the structure of the primary shape.
Primary Structure: As used in this disclosure, a primary structure refers to the component of an object that the other components attach to. The primary structure is also called the base structure.
Prism: As used in this disclosure, a prism is a three-dimensional geometric structure wherein: 1) the form factor of two faces of the prism are congruent; and, 2) the two congruent faces are parallel to each other. The two congruent faces are also commonly referred to as the ends of the prism. The surfaces that connect the two congruent faces are called the lateral faces. In this disclosure, when further description is required a prism will be named for the geometric or descriptive name of the form factor of the two congruent faces. If the form factor of the two corresponding faces has no clearly established or well-known geometric or descriptive name, the term irregular prism will be used. The center axis of a prism is defined as a line that joins the center point of the first congruent face of the prism to the center point of the second corresponding congruent face of the prism. The center axis of a prism is otherwise analogous to the center axis of a cylinder. A prism wherein the ends are circles is commonly referred to as a cylinder.
Reflection: As used in this disclosure, a reflection refers to the change of direction of a wave that occurs when the wave impacts a surface.
Refraction: As used in this disclosure, refraction refers to a change in angle of a wave direction (typically electromagnetic radiation or light) as the wave moves through a surface formed a first transparent material into a second transparent material. The angle is measured relative to an axis that is perpendicular to the surface at the point of contact with the wave. The relationship between the angle of the wave direction (relative to the perpendicular) through the first material and the angle of the wave direction (relative to the perpendicular) through the second material is given by Snell's Law. Snell's law states that n1*sin(a1)=n2*sin(a2) where nx is the index of refraction of material x and ax is the angle relative to the perpendicular in through material x. In this example, x is taken to be selected from the group consisting of the first transparent material and the second transparent material. The index of refraction is an empirically measured value. The index of refraction of a vacuum and the atmosphere is 1.0. The index of refraction of water is 1.33. The reported index of refraction of octane ranges between 1.38 and 1.40.
Sandwich: As used in this disclosure, to sandwich means to insert a first disk-shaped structure between a second disk-shaped structure and a third disk-shaped structure to form a composite prism structure. Specifically: a) a first congruent end of the first disk-shaped structure is placed against a first interior congruent end of the second disk-shaped structure; and, b) a second congruent end of the first disk-shaped structure is placed against a second interior congruent end of the third disk-shaped structure. A first exterior congruent end of the second disk-shaped structure forms a first overall congruent end of the overall composite prism structure described in this definition. A second exterior congruent end of the third disk-shaped structure forms a second overall congruent end of the overall composite prism structure described in this definition. The second overall congruent end of the overall composite prism structure is distal from the first overall congruent end. The verb to sandwich describes the act of placing the first disk-shaped structure between the second disk-shaped structure and the third disk-shaped structure.
Semitransparent: As used in this disclosure, semitransparent refers to an object that is partially transparent. By partially transparent is meant: a) that only a proportion of the light that strikes a semitransparent structure will pass through the semitransparent structure; and, b) that the light is scattered as it passes through the semitransparent structure such that objects cannot be clearly seen through the semitransparent structure. Use tinted when objects can be clearly seen.
Sheeting: As used in this disclosure, a sheeting is a material, such as a paper, textile, a plastic, or a metal foil, in the form of a thin layer. The sheeting forms a disk structure. The two surfaces of the sheeting with the greatest surface area are called the faces of the sheeting.
Solid: As used in this disclosure, a solid refers to a state (phase) of matter that: 1) has a fixed volume; and, 2) does not flow.
Solution: As used in this disclosure, a solution is a uniform mixture of two or more compounds in a liquid phase. The major component selected from the two or more compounds that forms the solution is called the solvent. The components remaining in the two or more compounds are called the solute. A polar solvent is a solvent formed from polar molecules. A non-polar solvent is a solvent formed from non-polar molecules. The rule of thumb that “like dissolves like” states that: a) solutes formed from polar molecules will dissolve in polar solvents but will not dissolve in non-polar solvents; and, b) solutes formed from non-polar molecules will dissolve in non-polar solvents but will not dissolve in polar solvents.
Switch: As used in this disclosure, a switch is an electrical device that starts and stops the flow of electricity through an electric circuit by completing or interrupting an electric circuit. The act of completing or breaking the electrical circuit is called actuation. Completing or interrupting an electric circuit with a switch is often referred to as closing or opening a switch respectively. Completing or interrupting an electric circuit is also often referred to as making or breaking the circuit respectively.
Tinted: As used in this disclosure, tinted refers to a tinted material that allows a reduced amount of light (relative to a transparent material) to pass through the tinted material without significant scattering such that an object can be clearly seen through the tinted material.
Transparent: As used in this disclosure, transparent refers to a material that allows light to pass through the material without significant scattering such that an object can be clearly seen through the material.
Variable Opacity Structure: As used in this disclosure, a variable opacity structure refers to a material with optical properties that vary when the variable opacity structure is exposed to an electric field. By optical properties is meant the reflective, refractive, and the diffractive properties of the variable opacity structure. The optical properties of the variable opacity structure vary as a function of the electric field intensity applied to the variable opacity structure. A change in the electric field intensity varies the optical properties by controlling the optical permittivity of the variable opacity structure. The electric field intensity can be varied to create an optical permittivity with optical properties ranging from: a) an optical permittivity with opaque and semitransparent properties; through, b) an optical permittivity of tinted properties that control the proportion of visible light that is transmitted through the variable opacity structure; to, c) an optical permittivity with transparent properties that allows full visibility through the variable opacity structure. The variable opacity structure is often referred to as switchable glass. The use of the term electric field in this definition is not intended to exclude the use of a magnetic field to accomplish the same purpose. The use of the term electric field in this definition is not intended to exclude the use of electric energy to accomplish the same purpose.
Vehicle: As used in this disclosure, a vehicle is a device that is used for transporting passengers, goods, or equipment. The term motorized vehicle specifically refers to a vehicle can move under power provided by an electric motor or an internal combustion engine. The term vehicle generically applies to motorized vehicles and vehicles without a motor. A motorized vehicle further comprises an electrical system that can be used as a source of electric energy. The enclosed passenger space of a vehicle is known as a cab.
Visible: As used in this disclosure, the term visible refers to the ability of an individual (referred to as a viewer) to see an object. The term visible implies that the direct “line of sight” between a viewer and the object does not have any opaque or semitransparent barriers between the viewer and the object that would inhibit the transmission of electromagnetic radiation between the viewer and the object. The term visibility is used to mean that an object is visible from the position of a viewer.
Window: As used in this disclosure, a window is an opening in the body of a vehicle that is fitted with glass or other transparent material in a frame to admit light or air and that allows people to see out. Windshields and windscreens are explicitly considered to be windows in this definition.

Windshield: As used in this disclosure, a windshield refers to the front and rear window of a vehicle that is intended to shield the occupants of the vehicle from the wind generated by the normal motion of the vehicle. Windscreen is a synonym for windshield. The pillars that secure the lateral faces of the front windshield to the vehicle are called the A-Pillars.

With respect to the above description, it is to be realized that the optimum dimensional relationship for the various components of the invention described above and in FIGS. 1 through 5 include variations in size, materials, shape, form, function, and manner of operation, assembly and use, are deemed readily apparent and obvious to one skilled in the art, and all equivalent relationships to those illustrated in the drawings and described in the specification are intended to be encompassed by the invention.

It shall be noted that those skilled in the art will readily recognize numerous adaptations and modifications which can be made to the various embodiments of the present invention which will result in an improved invention, yet all of which will fall within the spirit and scope of the present invention as defined in the following claims. Accordingly, the invention is to be limited only by the scope of the following claims and their equivalents.

What is claimed is:

1. A controlled vehicle window tinting system a variable opacity structure and a power circuit;
wherein the power circuit generates an electric field within the variable opacity structure;
wherein the controlled vehicle window tinting system is a transparent structure;
wherein the controlled vehicle window tinting system is a variable opacity window.

2. The controlled vehicle window tinting system according to claim 1
wherein the controlled vehicle window tinting system is formed from an electrochromic material;
wherein by variable opacity is meant that the level of tint of the controlled vehicle window tinting system is electrically controlled;
wherein by level of tint is meant the amount of light that passes through the transparent structure of the controlled vehicle window tinting system is adjustable;
wherein the variable opacity structure forms a solid and transparent barrier structure;
wherein the power circuit generates an electric field within the variable opacity structure that varies the level of tint of the of the variable opacity structure;
wherein the variable opacity structure remains transparent as the level of tint is adjusted.

3. The controlled vehicle window tinting system according to claim 2
wherein the variable opacity structure is formed with a variable opacity;
wherein the variable opacity structure allows for the adjustment of the level of tint of the light that is transmitted through the variable opacity structure;
wherein the variable opacity structure is a disk shaped structure;
wherein the variable opacity structure is a rigid structure;
wherein the variable opacity structure has a composite structure;
wherein the composite structure of the variable opacity structure is formed from plurality of laminae.

4. The controlled vehicle window tinting system according to claim 3
wherein the power circuit;
wherein the power circuit is an electric circuit;
wherein the power circuit electrically connects to the variable opacity structure;
wherein the power circuit generates an electric field that is applied to the variable opacity structure;
wherein the power circuit controls the level of tint of the variable opacity structure.

5. The controlled vehicle window tinting system according to claim 4
wherein the variable opacity structure comprises an exterior glass layer structure, an exterior transparent electrode structure, an exterior electrochromic material structure, a medial electrolyte solution, an interior electrochromic material structure, an interior transparent electrode structure, and an interior glass layer structure;
wherein the exterior glass layer structure forms a lamina of the composite disk structure of the variable opacity structure;
wherein the interior glass layer structure forms a lamina of the composite disk structure of the variable opacity structure;
wherein the exterior transparent electrode structure forms a lamina of the composite disk structure of the variable opacity structure;
wherein the interior transparent electrode structure forms a lamina of the composite disk structure of the variable opacity structure;
wherein the exterior electrochromic material structure forms a lamina of the composite disk structure of the variable opacity structure;
wherein the interior electrochromic material structure forms a lamina of the composite disk structure of the variable opacity structure;
wherein the medial electrolyte solution forms a lamina of the composite disk structure of the variable opacity structure.

6. The controlled vehicle window tinting system according to claim 5
wherein the power circuit comprises a voltage control structure, an exterior electrode lead, an interior electrode lead, and an electrolyte lead;
wherein the voltage control structure, the exterior electrode lead, the interior electrode lead, and the electrolyte lead are electrically interconnected.

7. The controlled vehicle window tinting system according to claim 6
wherein the exterior glass layer structure is a rigid structure;
wherein the exterior glass layer structure is a transparent structure;
wherein the exterior glass layer structure forms a congruent end of the composite disk structure of the variable opacity structure;
wherein the exterior glass layer structure is formed from glass;
wherein the interior glass layer structure is a rigid structure;
wherein the interior glass layer structure is a transparent structure;
wherein the interior glass layer structure is geometrically similar to the exterior glass layer structure;
wherein the interior glass layer structure forms a congruent end of the composite disk structure of the variable opacity structure;
wherein the interior glass layer structure forms the congruent end that is distal from the exterior glass layer structure;
wherein the interior glass layer structure is formed from glass.

8. The controlled vehicle window tinting system according to claim 7
wherein the exterior transparent electrode structure is an electrically conductive mesh structure;
wherein the exterior transparent electrode structure is sandwiched between the exterior glass layer structure and the exterior electrochromic material structure;
wherein the exterior transparent electrode structure is sandwiched between the exterior glass layer structure and the exterior electrochromic material structure such that the exterior transparent electrode structure does not inhibit the visibility through the variable opacity structure;
wherein the exterior transparent electrode structure forms an electric connection with the power circuit;
wherein the exterior transparent electrode structure receives a first voltage from the power circuit;
wherein the exterior transparent electrode structure presents the first received voltage to the exterior electrochromic material structure;
wherein the exterior transparent electrode structure is geometrically similar to the exterior electrochromic material structure such that the first received voltage presented by the exterior transparent electrode structure is evenly distributed over the congruent end of the exterior electrochromic material structure;
wherein the interior transparent electrode structure is an electrically conductive mesh structure;
wherein the interior transparent electrode structure is sandwiched between the interior electrochromic material structure and the interior glass layer structure;
wherein the interior transparent electrode structure is sandwiched between the interior electrochromic material structure and the interior glass layer structure such that the interior transparent electrode structure does not inhibit the visibility through the variable opacity structure;
wherein the interior transparent electrode structure forms an electric connection with the power circuit;
wherein the interior transparent electrode structure receives the first received voltage from the power circuit;
wherein the first received voltage is identical to the voltage received by the exterior transparent electrode structure;
wherein the interior transparent electrode structure presents the first received voltage to the interior electrochromic material structure;
wherein the interior transparent electrode structure is geometrically similar to the interior electrochromic material structure such that the first received voltage presented by the interior transparent electrode structure is evenly distributed over the congruent end of the interior electrochromic material structure.

9. The controlled vehicle window tinting system according to claim 8
wherein the exterior electrochromic material structure is a rigid structure;
wherein the exterior electrochromic material structure is a transparent structure;
wherein the exterior electrochromic material structure is geometrically similar to the exterior glass layer structure;
wherein the exterior electrochromic material structure is sandwiched between the exterior transparent electrode structure and the medial electrolyte solution;
wherein the exterior electrochromic material structure is formed from an electrochromic material;
wherein the exterior electrochromic material structure is formed from a variable opacity material;
wherein the level of tint of the exterior electrochromic material structure is adjustable;
wherein the level of tint of the exterior electrochromic material structure adjusts by adjusting the strength of an electric field that passes through the exterior electrochromic material structure;
wherein the interior electrochromic material structure is a rigid structure;
wherein the interior electrochromic material structure is a transparent structure;
wherein the interior electrochromic material structure is geometrically similar to the exterior glass layer structure;
wherein the interior electrochromic material structure is sandwiched between the medial electrolyte solution and the interior transparent electrode structure;
wherein the interior electrochromic material structure is formed from an electrochromic material;
wherein the interior electrochromic material structure is formed from a variable opacity material;
wherein the level of tint of the interior electrochromic material structure is adjustable;
wherein the level of tint of the interior electrochromic material structure adjusts by adjusting the strength of an electric field that passes through the interior electrochromic material structure.

10. The controlled vehicle window tinting system according to claim 9
wherein the medial electrolyte solution is a transparent structure;
wherein the medial electrolyte solution is sandwiched between the exterior electrochromic material structure and the interior electrochromic material structure;
wherein the medial electrolyte solution is a fluid impermeable structure;
wherein the medial electrolyte solution is an electrically conductive structure;
wherein the medial electrolyte solution contains a liquid phase electrolytic solution;
wherein the medial electrolyte solution forms an electric connection with the power circuit;
wherein the medial electrolyte solution receives a second voltage from the power circuit;
wherein the magnitude of the second received voltage medial electrolyte solution received from the power circuit is different from the magnitude of the first received voltage applied to the exterior transparent electrode structure from the power circuit;
wherein the magnitude of the second received voltage medial electrolyte solution received from the power circuit is different from the magnitude of the first received voltage applied to the interior transparent electrode structure from the power circuit;
wherein the medial electrolyte solution presents the second received voltage to the congruent end of the exterior electrochromic material structure that is distal from the exterior glass layer structure;
wherein the medial electrolyte solution is geometrically similar to the exterior electrochromic material structure such that the second received voltage presented by the medial electrolyte solution is evenly distributed over the congruent end of the exterior electrochromic material structure;
wherein the medial electrolyte solution presents the second received voltage to the congruent end of the interior electrochromic material structure that is distal from the exterior glass layer structure;
wherein the medial electrolyte solution is geometrically similar to the interior electrochromic material structure such that the second received voltage presented by the medial electrolyte solution is evenly distributed over the congruent end of the interior electrochromic material structure;
wherein the exterior transparent electrode structure, the exterior electrochromic material structure and the medial electrolyte solution combine to form an exterior capacitor structure;
wherein the exterior electrochromic material structure and the medial electrolyte solution form the conductive plates of the exterior capacitor structure;
wherein the exterior electrochromic material structure forms the dielectric material of the exterior capacitor structure;
wherein the voltage differential between the exterior transparent electrode structure and the medial electrolyte solution forms the electric field through the exterior electrochromic material structure that is used to control the level of tint of the exterior electrochromic material structure;
wherein the level of tint of the exterior electrochromic material structure is controlled by controlling the voltage differential between the medial electrolyte solution and the exterior transparent electrode structure;
wherein the interior transparent electrode structure, the interior electrochromic material structure and the medial electrolyte solution combine to form an interior capacitor structure;
wherein the interior electrochromic material structure and the medial electrolyte solution form the conductive plates of the interior capacitor structure;
wherein the interior electrochromic material structure forms the dielectric material of the interior capacitor structure;
wherein the voltage differential between the interior transparent electrode structure and the medial electrolyte solution forms the electric field through the interior electrochromic material structure that is used to control the level of tint of the interior electrochromic material structure;
wherein the level of tint of the interior electrochromic material structure is controlled by controlling the voltage differential between the medial electrolyte solution and the interior transparent electrode structure.

11. The controlled vehicle window tinting system according to claim 10
wherein the voltage control structure is an electric circuit element;
wherein the voltage control structure controls the flow of electric energy from the external power source into the exterior electrode lead, the interior electrode lead, and the electrolyte lead;
wherein the voltage control structure controls the voltage differential between the first voltage and the second voltage;
wherein the voltage control structure applies the first voltage to the exterior electrode lead and the interior electrode lead;
wherein the voltage control structure applies the second voltage to the electrolyte lead;
wherein the external power source is an externally provided source of electric energy;
wherein the external power source provides the power circuit with the electric energy required for operation;
wherein the exterior electrode lead is an electrically conductive structure;
wherein the exterior electrode lead is the structure of the power circuit that conducts the first voltage from the voltage control structure to the exterior transparent electrode structure;
wherein the interior electrode lead is an electrically conductive structure;
wherein the interior electrode lead is the structure of the power circuit that conducts the first voltage from the voltage control structure to the interior transparent electrode structure;
wherein the electrolyte lead is an electrically conductive structure;
wherein the electrolyte lead is the structure of the power circuit that conducts the second voltage from the voltage control structure to the medial electrolyte solution.
